(19) United States
(12) Patent Application Publication
(10) Pub. No.: US 2006/0078868 A1
(43) Pub. Date: Apr. 13, 2006

(54) Method and system for identifying barriers and gaps to E-learning attraction

(75) Inventors: Patricia Jeanne Douglas, Hillsboro, OR (US); Peter Gustav Fairweather, Yorktown Heights, NY (US); Janis Ann Morariu, Hardy, VA (US); Stephen Mitchell Rae, Marietta, GA (US); Yael Ravin, Mount Kisco, NY (US)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/963,947

(22) Filed: Oct. 13, 2004

(51) Int. Cl. G09B 25/00

(52) U.S. Cl. 434/365

(57) ABSTRACT

A computer system, method, program product, and service method for evaluating a learning program/service is disclosed with one or more databases having one or more variables. The invention systematically determines the attractiveness of the program/service, preferably a learning program, to one or more end users by determining one or more variables. Each of the variables defines one or more aspects of the learning program/service. An assessment value is associated with each of the variables. The assessment value is a combination of two or more importance assessments given by one or more of the users for each of the respective aspects. A provisioning value is also associated with each of the variables. The provisioning value is a combination of two or more availability assessments given by one or more stake holders for the respective aspect. Then an evaluation process determines a measure of comparison between the assessment value and the respective provisioning value for one or more of the respective variables. The invention may include an aggregation process that combines two or more of the measures to obtain a program measure that can be used to indicate an attractiveness of the learning program/service to the users.

### FIELD OF THE INVENTION

This invention relates to a system, method, and service for automated product and/or service design and/or analysis of learning programs. More specifically, the invention relates to determining and analyzing the effect of one or more product and/or service attributes on voluntary acceptance decisions for those products/services, particularly in the domains of education and training.

### BACKGROUND OF THE INVENTION

Although historical and cultural influences have associated learning with children, scientific investigation tracks it from before birth through the end of life, while the spread of adult education and training programs attest to the increasing social and economic value accorded it after childhood. Engaged participation, practice and problem-solving facilitates much of adult learning. Learners will participate in a learning activity if they have sufficient motivation to do so—if the factors that attract them to the learning experience or its outcome outweigh the ones that repel them. When competing learning alternatives are available, learners will choose the ones that maximize the attractive factors and minimize the negative ones.

In both formal and informal corporate training situations, many factors influence how attracted employees are to a learning program. Especially if participation is voluntary, employees have to weigh the benefits of the program against the demands of their job and their personal life.

Typically, before a learning program is launched within an enterprise, there is considerable effort devoted to gauging the potential success of the program. If the program is to be provided by a vendor, there is some process by which to compare the merits and cost of the different vendors, such as a bid process. External authorities provide feature lists which help compare products or services offered by different vendors. For example, EduTools http://www.edutools.info/course/index.jsp is a Web site that provides assistance to higher education institutions with a decision making process for choosing the best course management system for their needs. The site has product reviews, which include over 40 product features and provide automatic comparison by features.

Various consulting organizations such as Eduworks http://www.eduworks.com/ and Chief Learning Officer magazine http://www.clomedia.com/sourcebook/details.cfm?id=74 provide guidance for how to choose the best learning program for a given customer situation. Typically consulting includes an evaluation of the current learning programs and technologies in the corporation, an assessment of these against business objectives and goals, a set of meetings or workshops to discuss and distill these, and a resulting set of recommendations regarding strategy, architecture, technology, content development, procedures, etc. In evaluating or designing a particular learning program, these consulting agencies look at factors such as the quality of the learning experience, its alignment with corporate objectives, its operational feasibility (cost, available resources, etc), which are all essential to predicting effectiveness.

As more learning takes place online, learners become empowered to make their own decisions about their learning paths and select learning programs that best correspond to their needs. This shift of responsibility and choice from the employer to the employee underscores the importance of and motivates the need to identify and measure factors that contribute to or inhibit a successful online experience.

There are quite a few studies in the open literature which list factors that determine learning effectiveness. For example, Cashion & Palmieri provide a list of 11 factors that constitute a quality online learning experience and rank them in order of importance for determining this quality. (Cashion, J. and Palmieri, P. 2002 The Secret is the Teacher: The Learner's View of Online Learning. National Center for Vocational Education Research, Leabrook, Australia). The factors are: flexibility (24%), responsive teachers (15%), materials and course design (14%), access to resources (9%), online assessment and feedback (7%), increase in information technology (IT) skills (6%), learning style (6%), interaction with other students (5%), communication (5%), ease of use (3%), and hybrid mix of face-to-face and online learning (3%).

Muilenburg & Berge list categories which are perceived by learners to be barriers to online learning: administrative structure; organizational change; technical expertise, support, and infrastructure; social interaction and program quality; faculty compensation and time; threat of technology; legal issues; evaluation effectiveness; access; and student-support services. (Muilenburg, L. Y. and Berge, Z. L. 2001. Barriers to distance education: A factor-analytic study. The American Journal of Distance Education. 15(2): 7-22.)

Outside of the learning domain proper, work has been done in collecting the factors that determine the gravitation of employees to voluntary information technology (IT) programs deployed in the enterprise. One study in particular (Venkatesh, V., Morris, M., Davis, G., and Davis, F. “User Acceptance of Information Technology: Toward a Unified View”, MIS Quarterly, V27 n3, pp 425-478, Sep. 2003) has integrated eight previously established models into one unified model to predict the “individual acceptance of information technology”. The model was empirically tested and then cross validated and explained 79% of the variance in observed IT usage. The model includes 3 factors that determine gravitation to IT deployments: performance expectancy (how will this help me with my job?), effort expectancy (how difficult will this be to use?) and social influence (what will others think about my use of this technology?). In addition, the authors include 2 direct determinants of usage behavior and several other moderating influences.

The above cited references are herein incorporated by reference in their entirety.

### PROBLEMS WITH THE PRIOR ART

Services that provide automatic feature comparisons of products do not tailor the comparison to the specific conditions of the customer. Without assessing the relevance of each feature to the particular conditions of the enterprise, the value of these rigorous product comparisons to determine the potential success of a learning program is limited. Consulting agencies do relate their analysis to the particular conditions of their customers, but they do not systematically measure the motivation the learners will have to engage in the programs being evaluated. They may employ such known techniques as focus groups, to get an intuitive sense of the learners' perspective, or suggest a process of incentives to encourage employee participation, but they do not employ a systematic and rigorous method to assess the “gravitation” learners will have towards a proposed learning program. The learner perspective is not systematically broken down to the many factors that contribute to it. As a result, it could well happen that a learning program that seems effective before deployment is still unsuccessful because learners are not motivated to experience it.

State-of-the-art studies of predictors and inhibitors of online learning experiences (as mentioned above) list factors and in some cases even rank them in order of importance, but fail to arrange them into an analytic model that allows a systematic scoring of each factor and an overall score of expected effectiveness for the total learning deployment. This lack of an analytic model has the following consequences: 1) it is not clear how to measure the presence or absence of each factor, or if present—to what degree, since there are no clear set of measures associated with a factor, or a precise methodology for how to estimate it 2) it is not clear how to combine the contribution of each factor into an overall score for the predicated effectiveness of a learning deployment 3) it is not clear what corrections should be made, i.e. what factors should be changed, in order to have a favorable effectiveness expectation 4) there is no combination of factors as they are perceived by learners with factors as they are perceived by the learning providers or administrators to provide an overall model.

It is our belief that failing to systematically and accurately gauge the learner's expected attraction to a particular program before it is invested in can result in a less effective deployment. The Venkatesh et al. study on user acceptance of IT does provide an analytic model, but it is not applied to learning per-se, rather to acceptance to other kinds of IT deployments, such as databases, accounting systems or online calendaring. We believe that some factors influencing learning will be the same (e.g., how will the technology improve performance on the job) but many others are irrelevant or missing. In addition, the Venkatesh et al. study is limited in several ways: 1) it is based on interviews conducted with users, taking into account the user perspective, but fails to correlate it with the provider or administrator perspective. We believe that the prior art fails to provide this correlation, or the identification of areas in which there is no good correlation between these perspectives, which indicates how the particular customer situation should be modified to improve the expected effectiveness of the learning program. 2) The model is not granular enough—it identifies generic factors that predict IT use across many industries and many applications. We believe that in order to be an effective consultancy tool, the model needs to be sensitive to the particular industry 3) In order to best predict the effectiveness of a learning program, the model needs to be continuously updated and learn from case studies. Venkatesh et al used case studies to cross-validate their model, but did not establish a system by which each case study, with precise weighting of many factors and sub-factors, actually serves to refine the model. 4) Aggregated models such as Venkatesh et al that are constructed based on pooling of data across hypothesized or presumptively similar variables do not bear the standard of evidence of an analysis built wholly out of empirical data collected within a uniform context.

### ASPECTS OF THE INVENTION

An aspect of this invention is an improved system, method, and service method for providing a systematic measure of attractiveness of a learning program to one or more prospective users.

An aspect of this invention is an improved system, method, and service method for providing a product and/or service provider one or more systematically obtained measures of learning product/service attractiveness to a prospective user.

An aspect of this invention is an improved system, method, and service method for providing a learning product and/or service provider one or more systematically obtained measures of a learning product/service attractiveness to a prospective user that are used to identify barriers to successful deployment of the learning product/service.

An aspect of this invention is an improved system, method, and service method for providing a product and/or service provider a redesign of the product/service using one or more systematically obtained measures of learning product/service attractiveness to one or more prospective users.

An aspect of this invention is an improved system, method, and service method for providing a redesign of a learning product and/or service using one or more systematically obtained measures of product/service attractiveness and product/service feedback to provide one or more prospective users a more attractive product/service.

An aspect of this invention is an improved system, method, and service method for providing consulting services to design and/or redesign product and/or services using one or more systematically obtained measures of product/service attractiveness to one or more prospective users.

An aspect of this invention is an improved system, method, and service method for providing consulting services to design and/or redesign product and/or services using one or more systematically obtained measures of the product/service to identify aspects of the product/service to change in order to improve attractiveness to one or more prospective users.

### SUMMARY OF THE INVENTION

The present invention is a computer system, method, program product, and service method for evaluating, designing, and/or redesigning a voluntary program, product, and/or service (program). The invention systematically determines the attractiveness of the voluntary program, preferably a learning program, to one or more (voluntary) end users by determining one or more variables. Each of the variables defines one or more aspects of the (learning) program. An assessment value is associated with each of the variables. The assessment value is a combination of two or more importance assessments given by one or more of the users for each of the respective aspects. A provisioning value is also associated with each of the variables. The provisioning value is a combination of two or more availability assessments given by one or more stake holders for the respective aspect. Then an evaluation process determines a measure of a difference between the assessment value and the respective provisioning value for one or more of the respective variables. The evaluation process also provides a report of the measure with the respective aspects. In an alternate embodiment, the invention includes an aggregation process that combines two or more of the measures to obtain a program measure. The program measure indicates an attractiveness of the learning program to the users. Alternative embodiments of the invention are service methods for providing consulting services to evaluate, design, or redesign product and/or services provided to users.

### BRIEF DESCRIPTION OF THE FIGURES

The foregoing and other objects, aspects, and advantages will be better understood from the following non limiting detailed description of preferred embodiments of the invention with reference to the drawings that include the following:

FIG. 1 is a block diagram of one example embodiment of a system using the present invention.

FIG. 2 is one embodiment of a flow chart of the process performed by the present invention.

FIG. 3 is a block diagram of a generic client survey.

FIG. 4 is an illustration of an assessment and provisioning representation.

FIG. 5 is a flow chart of an alternative process performed by the present invention.

### DETAILED DESCRIPTION OF THE INVENTION

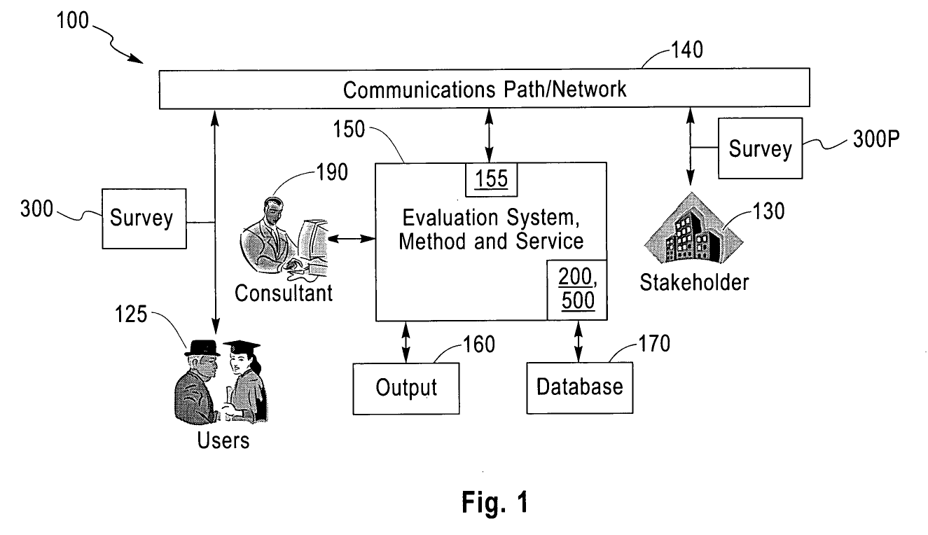

FIG. 1 is a block diagram 100 of one example embodiment of a system, method, and service using the present invention. The evaluation part of the invention 150 evaluates the attractiveness of one or more learning programs/information for one or more end users 125 with respect to the cost (e.g., time, money, effort, resources, facilities, and people) of providing the learning programs/information to the stake holder 130. In a preferred embodiment, the evaluation part of the invention 150 comprises a general purpose computer system 150 communicating with one or more databases 170. Some information in the databases 170 is precompiled or received over a communication path 140. In a preferred embodiment, the communications path 140 is one or more well-known network paths (e.g., internet, intranet, cable network, or phone network) connected to the evaluation system 150 through one or more known connections 155. However, the communication path 140 can also be a human service provider. Data in the database 170 may also be provided from past historical information or from other sources.

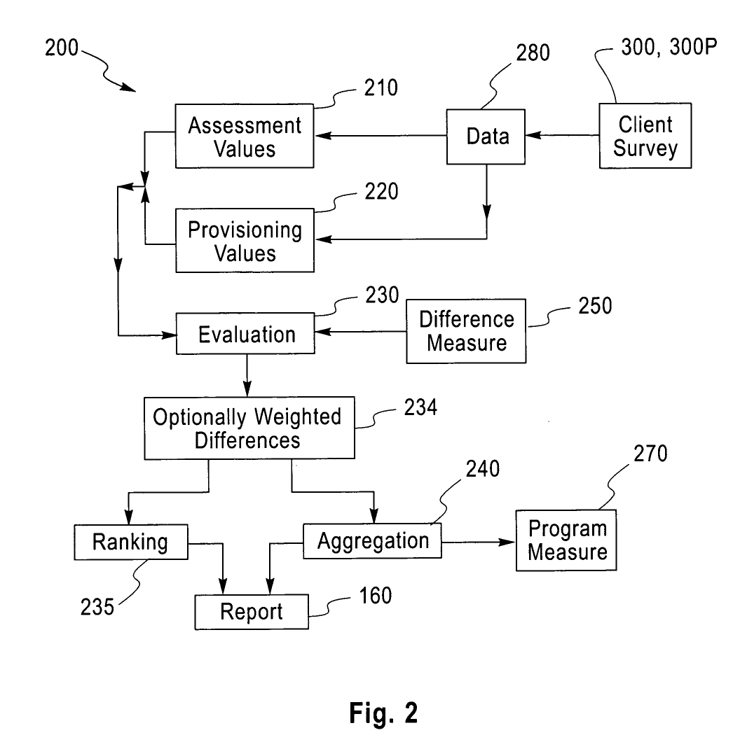

The end users 125 each provide two or more importance assessments that are combined into an importance or assessment value 210 (see FIG. 2) that is associated with each variable/aspect of the learning program/service. In a preferred embodiment, the importance assessments are provided on a user survey 300 given to the end users 125.

A provisioning value 220 (see FIG. 2) is also associated with each of the variables/aspects. The provisioning value is a combination of two or more availability assessments given by one or more stake holders 130 for the respective variable/aspect. Stake holders 130 may give their availability assessments through a hard copy stake holder survey 300P. The availability assessments may also be provided to the system or service provider through a survey through the communications path 140.

Alternative ways of surveying (300, 300P) information from the users 125 and stake holders 130 include: a face-to-face interview, an interview form, an on-line form, a conference call, and a focus group.

The databases 170 store one or more of the variables for one or more evaluations. Each variable defines one or more aspects of the learning program/service. The databases 170 also may store the importance assessments, importance values, provisioning values 220, availability assessments, and/or comparisons between the importance values 210 and provisioning values 220 (e.g., such as the difference between the importance and provisioning values).

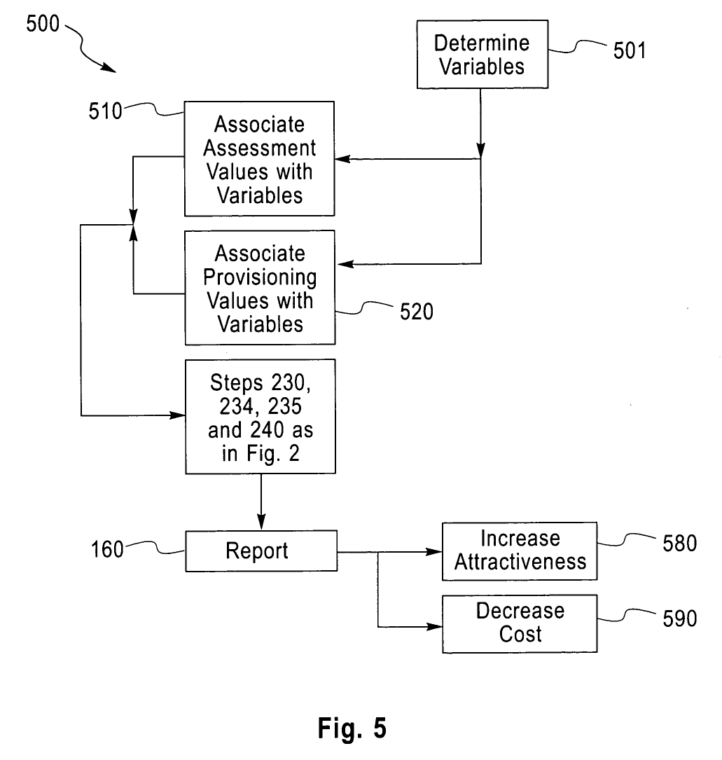

An evaluation process (200, 500), in alternate preferred embodiments described in FIGS. 2 and 5 below, compares (e.g., determines a measure of a difference between) the assessment value 210 and the respective provisioning value 220 for each respective variable. The evaluation process (200, 500) further provides a report (output 160) of a variable comparison measure (measure) associated with the respective aspects.

In preferred embodiments, the users 125 may include any one or more of the following: a soldier, an employee, a university student, a customer, an elementary school student, a high school student, a retired person, an e-learning student, a continuing education student, a web user, and a person with a special interest.

A user 125 can also be an ad hoc user who is not officially continuing education or is not officially an e-learning “student”, but rather, a person (like a web user) who wants to learn how to do a one time or special purpose task. For example, an ad hoc user might want to learn how to build a deck and might access a web site of a material supplier like Home Depot in order to learn building techniques. Thus the invention 100 could be used to design a web site or an e-learning presentation and/or format that is appealing to the needs of such an ad hoc or specialized user.

In preferred embodiments, the stake holder 130 may include one or more of the following: an e-learning provider, a publisher, an aggregator, a corporate officer, a government, a government agency, a university, an e-learning institution, a corporation, a community college, an online university, an online high-school, an online elementary school, a certification program, and an industry association.

In one preferred embodiment of the invention, services are provided to the end users 125 and/or the stakeholders 130. In an example of this embodiment, a consultant 190 would use the invention to determine the most effective way to increase the attractiveness of the learning program/service to the user with the minimum cost to the stakeholder. The consultant/service provider 190 might also recommend changes to the learning program/service that increase the attractiveness to the user 125 and/or reduce the cost to the stake holder 130. In alternative embodiments, the consultant/service provider 190 would design, re-design, or change the learning program/service and/or implement such modifications.

Thus the consultant 190 or service provider 190 would use the invention 100 to provide recommendations to the stake holder 130. The consultant could use the invention 100 to design, re-design, and/or change the stake holder's learning program/service. Alternatively, the consultant would evaluate existing and/or proposed learning systems to determine what needs to be added, deleted, or modified to make the learning program/service more accessible to the targeted users 125. The consultant 190 would also use the system 100 to determine what needs to be added, deleted, or modified to make the learning program/service less costly and/or more convenient for the stake holder 130 to make the learning program/service available to the user 125. Therefore, in some embodiments, these recommendations and learning system designs, re-designs, and/or changes would also be output 160 of the system 100.

In a preferred embodiment, the invention 100 uses an evaluation process 200 further described in FIG. 2. The evaluation process 200 determines a measure of comparison (e.g., a difference) between the assessment value and the respective provisioning value for one or more of the respective variables. The evaluation process 200 further provides a report, e.g. an output 160, of the measure with the respective aspects. Alternative embodiments of the evaluation process 200 are described in FIG. 2.

In an alternative preferred embodiment, the invention includes an aggregation process 240 (see FIG. 2) that combines two or more of the variable measures (measures) to obtain a program measure. The program measure gives an indication of an attractiveness of the entire learning program/service to the users 125 and/or the cost of the program to the stake holder 130.

There are alternative preferred formats for the output 160. Preferred outputs include an evaluation report that associates one or more measures with the respective aspects. One preferred output 160 provides a ranking of the program aspects by (variable) measure. This is can be done with standard ranking algorithms.

In providing a consulting service, the consultant 190 often makes recommendation to modify or modifies the learning program/service to optimize the program/service effectiveness. This is accomplished by providing program aspects that are most attractive to the users with the minimum cost to the stake holder 130. In some preferred embodiments, the consultant optimizes the program effectiveness by decreasing the measured difference for one or more of the aspects in order to increase the attractiveness of the learning program/service to the users and/or decrease the cost to the stake holder 130. Therefore, the learning program/service might be modified (or proposed to be modified) for aspects when the assessment value is high and the provisioning value is low and when the assessment value is low and the provisioning value is high.

An alternative preferred output format 160 pre-selects certain of the program aspects/variables. For example, the aspects with high assessment values and/or the aspects with low provisioning values might be pre-selected. In this example, the consultant 190 and/or stake holder 130 would know which aspects are most attractive to the users 125 (the ones with high assessment values) and which are least costly to provide (low provisioning values). If the invention identifies an aspect with a high assessment value and a low provision value that is not in the learning program/service, the stake holder 130 and/or consultant 190 becomes aware of a way to increase the attractiveness of the learning program/service at a low cost. In alternative embodiments, this information (pre-selected assessment values and provisioning values) can be ranked.

FIG. 2 is a flow chart of one embodiment of the process 200 performed by the present invention.

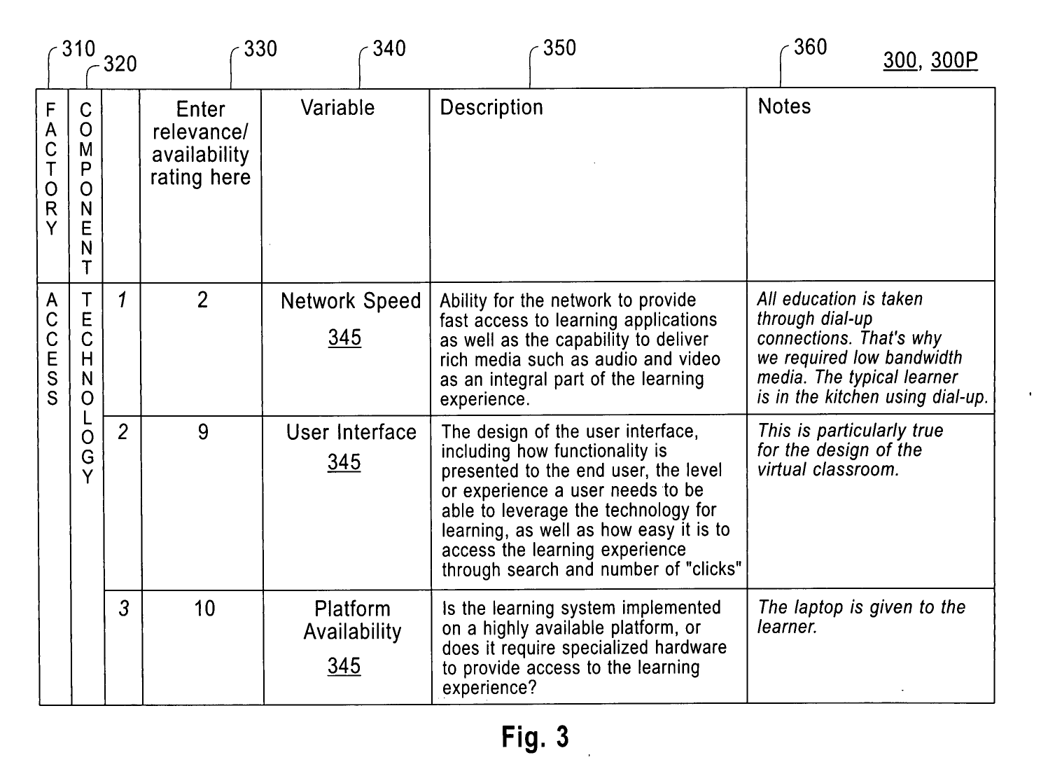

In a preferred embodiment, assessment values 210 are obtained by asking individual users 125 to fill out a survey 300, exemplified in FIG. 3. In this example, users are asked to rate each variable mentioned in the survey, on a scale of 1-10, according to how important that variable is in determining their motivation to participate in the learning program/service. The values assigned could be numeric (e.g., a scale of 1-10) or could be verbal (e.g., high, medium, low). If verbal, the values will be translated later into a numerical scale.

The results of the surveys—importance values assigned by each users—are captured in Data 280 and stored in the database 170. The importance values from individual users in Data 280 can be combined to yield assessment values 210 for each variable. In one preferred embodiment, the importance values are averaged (arithmetic mean) to yield assessment values 210. Other known methods can be used to combine the importance values.

Similarly, provisioning values are obtained from providers or stakeholders 130. In the preferred embodiment, provisioning values 220 are obtained by asking the stake holders to fill out a survey, exemplified in FIG. 3. Stake holders are asked to rate each variable mentioned in the survey, on a scale of 1-10, according to how well the learning program/service is able to provide this variable to the learner. The results of the surveys—availability assessments from each stake holder—are compiled in Data 280 and stored in the database 170. The values from individual stake holders are combined (e.g., by arithmetic mean, etc.) to yield provisioning values 220 for each variable.

An evaluation step 230 compares the assessment value (U) and the provisioning value (P). In a preferred embodiment, the evaluation step 230 compares these values by calculating a difference between the assessment value (U) and the provisioning value (P) of each variable to obtain a measure (here a difference measure) 250 and outputs 160 a set of one or more measures 234. One such measure, a difference measure, subtracts the provisioning value from the assessment value to obtain the difference:
Difference Measure=U−P (250)

This will provide the difference in absolute terms. A variant on the difference measure is to make the measure weighted, rather than absolute, by multiplying the difference by the assessment value:
Weighted Difference Measure=Difference*U=(U−P)*U (250)

This weighted difference takes into account the importance users attach to each variable, so that differences in highly important variables are greater (ignoring sign) than differences in less important variables.

Other methods for establishing weights for weighted differences 234 can be used in addition, or instead of, the above weighting scheme. Weights can be determined on the basis of historical weights, available in the database 170. For example, weights may be used that were established for assessments of the attractiveness of prior learning programs and/or services, especially if the prior programs/services are determined to be similar to the program/service currently being assessed. Weights can also be assigned a-priori based on the knowledge and expertise of the service provider 130 or consultant 190 (e.g., the program variable/aspect disconnected availability of the program/service is known to be more important for mobile employees than program variable/aspect available bandwidth). From our findings there are common assessment variable weightings based on the goals of the program/service and the profile of the learners/audiences that relate to the business or industry involved (e.g., higher/continuing education, financial services training, healthcare services training, etc.). Weights can be predetermined values. Finally, the weighted difference 234 can be adjusted or normalized by using constants, in conventional ways.

Another embodiment of measure 250 is where the measure multiplies the respective assessment and provisioning values for each variable to obtain an aspect measure.

In a preferred embodiment, the measures 250 (e.g. difference measures 250) for each variable obtained in the evaluation 230 are aggregated in the Aggregation process 240 to obtain an overall program measure 270. Any known aggregation method can be used, such as the closeness of two vectors in a multi-dimensional vector-space, often used in information retrieval. (See “The Vector Space Model Tutorial Presentation”, available at http://www.scit.wlv.ac.uk/˜jphb/cp4040/mtnotes/1, which is herein incorporated by reference in its entirety.) The aggregation in this case will compute the cosine of the angle existing between two vectors—one vector comprised of all the assessment values and the other vector comprised of all of the provisioning values.

In some embodiments, the program measure 270 serves as input to the service method described in FIG. 1 above. Here the service provider/consultant 190 identifies, modifies, or recommends modification of the one or more of the program aspects (variables) to optimize the program measure.

In alternative embodiments, the aspects or variables of the learning program/service can be ranked in a ranking step 235 according to the results of the evaluation 230. For example, from highest to lowest weighted difference. Other factors can be used to define other ranking methods, or added to further refine the rank of the variables. For example, the variables are ranked by the cost it will take to decrease their weighted differences, from lowest cost to highest cost. This ranking can be done to all of the variables evaluated in 230, or to a pre-selected set only.

Finally, a report 260 is issued 160 detailing the aggregated evaluation obtained in 240. The purpose of the report is to highlight the provisioning of variables that should be addressed to either increase the attractiveness of the learning program/service to the users or to decrease the cost of provisioning.

FIG. 3 is a block diagram of a generic client survey illustrating one embodiment of a survey 300 and that is administered to end users (learners) and/or to stakeholders to determine assessment values and provisioning values respectively.

In preferred embodiments, note that the surveys 300 and 300P are identical, except for Column 330—end users enter relevance values but stakeholders enter accessibility values. Variables may be just listed in a flat list, or as shown in FIG. 3, the variables 340 are categorized in one or more components 345. Variables can also be categorized into one or more factors 310, such as quality, value, and access. A hierarchical structure can be used to categorize variables into components and components into factors. Column 350 provides a description that can be used to clarify the meaning of the variable to the user or stakeholder. Notes 360 are provided by the users or stakeholders to justify their relevance or accessibility ratings.

In a preferred embodiment, the variables 340 are categorized in one or more of the following factors 310: quality, value, and access. Examples of the quality factor 310 include one or more of the following components 345: production values, individualization, and end user support. Examples of the value factor 310 include the following components 345: measurement, incentive, time, and performance. Examples of the access factor 310 include one or more of the following components 345: technology, cost, awareness, time, mobility, and selection.

In some embodiments, the Access components define a learner's ability to get to a desired or needed learning experience, and include components such as technology, cost and awareness. Access components are the most tangible and most measurable. The Quality components define a learner's experience during the learning event or process. Quality components are more subjective but can be measured with the help of content and instructional design guidelines. The Value components define the learner's perception of outcomes of the learning experience. Value cannot be measured, but is assessed by learners subjectively.

The table below gives some non limiting examples of factors 310, components 345 for each factor 310, and variables/aspects relating to each component 345. There is also a description of each example component/variable and how a high user (stake holder) rating and a low user (stake holder) rating would be interpreted.

| Factor | Component | Variable | Description | High = 10 | Low = 1 |
|---|---|---|---|---|---|
| Access | Technology | Network Speed | Ability for the | Highly available | Little to no access |
| | | | network to | networks | to a learning |
| | | | provide fast | capable of | network, |
| | | | access to | delivering live | characterized by |
| | | | learning | and static rich | either no system |
| | | | applications as | media based | available to |
| | | | well as the | learning | connect to, or slow |
| | | | capability to | experiences. | network speeds |
| | | | deliver rich | | limiting access to |
| | | | media such as | | learning |
| | | | audio and | | experiences. |
| | | | video as an | | |
| | | | integral part of | | |
| | | | the learning | | |
| | | | experience. | | |
| | | User Interface | The design of | User interface | User interface |
| | | | the user | is clean, | provides an |
| | | | interface, | intuitive, and | excessive set of |
| | | | including how | adaptive to | complex |
| | | | functionality is | learner | functionality that |
| | | | presented to | preferences. | requires significant |
| | | | the end user, | Minimal | investment from |
| | | | the level or | navigation | the learner in order |
| | | | experience a | required to | to access basic |
| | | | user needs to | access critical | functions. |
| | | | be able to | functions and | Functionality |
| | | | leverage the | learning | layers force the |
| | | | technology for | experiences | user through |
| | | | learning, as | | excessive |
| | | | well as how | | navigation in order |
| | | | easy it is to | | to access learning |
| | | | access the | | experiences. |
| | | | learning | | |
| | | | experience | | |
| | | | through search | | |
| | | | and number of | | |
| | | | “clicks” | | |
| | | Platform | Is the learning | Platform is | Platform is highly |
| | | Availability | system | pervasive, easy | specialized, |
| | | | implemented | to access, and | experimental, or |
| | | | on a highly | incorporates | unique to one |
| | | | available | existing | learning |
| | | | platform, or | platform | experience. Not |
| | | | does it require | infrastructure | widely available |
| | | | specialized | that is familiar | across learner |
| | | | hardware to | and available to | population |
| | | | provide access | the end user. | |
| | | | to the learning | | |
| | | | experience. | | |
| | Cost | Opportunity | When learners | Learning is | Cost of time away |
| | | Cost | are having a | “embedded” in | from the job or |
| | | | learning | job processes | other activity is |
| | | | experience, | in a seamless | highly expensive, |
| | | | what is the | way, so that | limiting user |
| | | | opportunity | there is minimal | motivation to |
| | | | cost of the | interruption of | participate in |
| | | | time | the job | learning |
| | | | commitment to | process. | experiences. |
| | | | the learning | | |
| | | | experience. | | |
| | | Time Cost | How much | The learning | The learning |
| | | | time do | experience | experience takes |
| | | | learners have | takes minutes | days or weeks to |
| | | | to invest to | to complete | complete |
| | | | gain access to | | |
| | | | the learning | | |
| | | | experience. | | |
| | | Cost to Student | What is the | There is not | The cost to the |
| | | | cost to the | cost to the | student is high |
| | | | individual | student | |
| | | | learner to | | |
| | | | engage in the | | |
| | | | learning | | |
| | | | experience | | |
| | | Cost to | What is the | The costs to | The cost of |
| | | Institution | cost to the | the institution | development or |
| | | | institution that | are very low | acquisition of the |
| | | | the learner is | compared to | content and the |
| | | | part of to | alternatives | cost of delivery are |
| | | | provide the | | high to the |
| | | | learning | | institution on a per |
| | | | experience | | learner basis |
| | | Cost of Platform | What is the | There is no | Specialized |
| | | | cost of the | incremental | delivery platforms |
| | | | delivery | platform cost to | are required that |
| | | | platforms | infrastructure | have a high cost to |
| | | | required to | already in place | the institution, may |
| | | | provide the | to deliver the | be limited in use, |
| | | | learning | learning | and require |
| | | | experience to | experience | specialized |
| | | | the intended | | maintenance, or |
| | | | audience | | are suspect to theft |
| | | | | | or breakage |
| | Awareness | Knowledge of | What percent | All learners are | A large percentage |
| | | system | of your | aware of the | of learners are not |
| | | | learning | learning system | aware that the |
| | | | audience is | and how to | learning |
| | | | aware of the | access learning | experiences exist |
| | | | system(s) | experiences | or are accessible |
| | | | available to | | |
| | | | access | | |
| | | | learning | | |
| | | | experiences. | | |
| | | Communication | How is the | A | No communication |
| | | Plan | learning | comprehensive | plan for learning |
| | | | system(s) | learning | system or |
| | | | capability and | communication | organizational |
| | | | availability | plan is in place | values for learning |
| | | | being | with emphasis | |
| | | | communicated | on the | |
| | | | to the intended | institutional | |
| | | | audience. | values being | |
| | | | | emphasized, | |
| | | | | and a | |
| | | | | compelling call | |
| | | | | to action for | |
| | | | | learners to | |
| | | | | engage | |
| | | | | learning | |
| | | | | experiences | |
| | | | | that are | |
| | | | | enforced in the | |
| | | | | management | |
| | | | | system | |
| | | Executive | What is the | Visible | No executive |
| | | Commitment | visible | executive | sponsorship |
| | | | executive | sponsorship | |
| | | | commitment to | that is an | |
| | | | the learning | integral part of | |
| | | | programs | the | |
| | | | | communication | |
| | | | | plan, | |
| | | | | organizational | |
| | | | | values, and | |
| | | | | incentive | |
| | | | | system. | |
| | Time | Time Spent in | How much | Very little time | Most of the time is |
| | | Search | time is spent | is spent in | spent looking for |
| | | | looking for a | search, with | relevant learning |
| | | | relevant | learner profiles | experiences |
| | | | learning | augmenting | |
| | | | experience | speed of | |
| | | | | access to | |
| | | | | relevant | |
| | | | | learning | |
| | | | | experiences. | |
| | | Time Spent in | How much | The learning | Time spent in |
| | | Course | time is spent in | experience | learning |
| | | | the learning | minimizes time | experience is |
| | | | experiences | spent learning | excessive, and |
| | | | | to only what | only provides |
| | | | | was needed by | limited relevancy |
| | | | | the learner. | to the learning |
| | | | | Minimizes time | need |
| | | | | away from the | |
| | | | | job. | |
| | | Latency from | How much | Seconds or | A month or more |
| | | point of need | time elapses | minutes | elapses from when |
| | | | between the | | the learning need |
| | | | time the | | is identified to |
| | | | learning need | | when it is delivered |
| | | | is identified | | |
| | | | and when the | | |
| | | | learning | | |
| | | | experience | | |
| | | | occurs. | | |
| | Mobility | Portability of | Can the | Learning | Learning |
| | | experience | content be | experience can | experience has |
| | | | moved easily. | be delivered | environmental and |
| | | | How easy is it | anywhere | platform |
| | | | to get the | anytime | requirements that |
| | | | content to the | | limit the |
| | | | learning | | experience to one |
| | | | experience | | facility or location |
| | | Portability of | How portable | Player device is | Player device is |
| | | Player | is the learning | portable, | limited to a fixed |
| | | | environment or | lightweight, and | location. |
| | | | platform. | can be used in | |
| | | | Does the | a disconnected | |
| | | | learner have to | state. | |
| | | | come to the | | |
| | | | learning | | |
| | | | experience, or | | |
| | | | can the | | |
| | | | learning | | |
| | | | experience be | | |
| | | | brought to the | | |
| | | | learner. | | |
| | | Proximity to | How close is | Learning | Learner is required |
| | | Learner | the learning | experience is | to travel to learning |
| | | | experience to | immediately | experience, and |
| | | | the learner | available to the | will incur travel |
| | | | | learner | expenses to gain |
| | | | | regardless of | access to |
| | | | | their location. | experience |
| | Selection | What is needed | Can the | The learner has | The learner has a |
| | | is available | learner find the | a large | very limited |
| | | | content they | selection of | selection of |
| | | | need. How | learning | learning topics |
| | | | large is the | experiences | which may not be |
| | | | selection of | available in | relevant to their |
| | | | learning | multiple | needs |
| | | | experiences | delivery | |
| | | | available to | formats and | |
| | | | the learner. | can always find | |
| | | | | a learning | |
| | | | | experience that | |
| | | | | addresses a | |
| | | | | learning need | |
| Quality | Production | Level of | How | Content has | No consideration |
| | Values | Instructional | sophisticated | been highly | for Instructional |
| | | Design | is the | processed to | Design methods |
| | | | instructional | enhance the | has been given to |
| | | | design, and | learning | content |
| | | | how well has it | experience and | |
| | | | been mapped | deliver on the | |
| | | | to learning | intended | |
| | | | objectives that | learning | |
| | | | reflect the | outcomes | |
| | | | learners needs | | |
| | | | and | | |
| | | | organizational | | |
| | | | intent | | |
| | | Level of | How | Content is | Content has no |
| | | Interactivity | interactive is | highly | interactivity, and |
| | | | the content, | interactive, | does not engage |
| | | | and does it | motivates and | the learner |
| | | | provide an | engages the | |
| | | | engaging | learner, and | |
| | | | learning | maximizes | |
| | | | experience | retention as an | |
| | | | | outcome. An | |
| | | | | immersive | |
| | | | | simulation is an | |
| | | | | example of this | |
| | | | | type of learning | |
| | | | | experience. | |
| | | Media Strategy | What level of | Multi-media | Text only |
| | | | media has | capability, | |
| | | | been included | including live | |
| | | | in the learning | and static | |
| | | | experience. | media. | |
| | | | Does it include | | |
| | | | audio and | | |
| | | | video, and are | | |
| | | | live media | | |
| | | | based learning | | |
| | | | situations | | |
| | | | available to | | |
| | | | the learner | | |
| | Individualized | Meets individual | Is the learning | The learners | Every learner gets |
| | | learner needs | experience | individual | the same learning |
| | | | able to be | needs filter the | experience |
| | | | delivered in a | learning and | |
| | | | tailored and | provide a | |
| | | | personalized | unique | |
| | | | way to the | experience for | |
| | | | learner, just | the learner | |
| | | | what they | | |
| | | | need | | |
| | | Available in | Is the learning | The learning | Only one learning |
| | | multiple formats | experience | experience is | format is available |
| | | | available in | available in | |
| | | | multiple | multiple | |
| | | | formats to | delivery | |
| | | | address | formats and | |
| | | | learning style | media | |
| | | | preferences of | strategies that | |
| | | | the learner. | address the | |
| | | | | aggregate | |
| | | | | learning styles | |
| | | | | of the intended | |
| | | | | audience | |
| | | Navigable in | To what | Seamless | No bookmarking, |
| | | small segments | degree is the | bookmarking, | single path, and |
| | | with | learning | modular, with | provides no ability |
| | | bookmarking | experience | estimates of | for the learner to |
| | | | designed to be | learning time | access specific |
| | | | navigable in | provided, with | components of the |
| | | | small | ability to pretest | material in active |
| | | | segments, with | out of material. | learning or in |
| | | | bookmarking | | reference mode. |
| | | | available to | | |
| | | | support | | |
| | | | learning in | | |
| | | | small | | |
| | | | segments of | | |
| | | | time. | | |
| | | Shareable | Has the | SCORM | Content has no |
| | | Content Objects | content been | Compliant with | metadata that |
| | | | developed to | extensive | would provide the |
| | | | be searched | metadata that | ability to search it |
| | | | and delivered | provides simple | in a standardized |
| | | | as a self | search | manner. |
| | | | contained | interfaces and | |
| | | | learning object | allows reuse | |
| | | | that addresses | across topics | |
| | | | the needs of | and audiences. | |
| | | | the learner. | Can run in | |
| | | | | multiple | |
| | | | | learning | |
| | | | | systems. | |
| | End User | Level or extent | What level or | Call center | End users have to |
| | Support | of support or | how extensive | available 24 × 7 | figure it out on |
| | | expertise | is the end user | with targeted | their own. |
| | | available | support or | help, FAQs, | |
| | | | expertise | and access to | |
| | | | provided. | experts and/or | |
| | | | | peer if and | |
| | | | | when needed. | |
| | | Usefulness of | How useful is | Highly useful | Minimal or no |
| | | support or | the end user | end user | usefulness in |
| | | expertise | support or | support offered. | addressing/solving |
| | | | expertise that | On target, just | end user |
| | | | is available. | right, just | questions. |
| | | | | enough support | |
| | | | | provided to | |
| | | | | address/solve | |
| | | | | end user | |
| | | | | questions. | |
| Value | Measurement | Are outcomes | To what | Outcomes are | No outcomes are |
| | | being measured | degree are | aligned with | being measured |
| | | | learning | key business | |
| | | | outcomes | metrics that | |
| | | | being | provide | |
| | | | measured | relevancy to | |
| | | | beyond | the learner and | |
| | | | participation | are a source of | |
| | | | | incremental | |
| | | | | motivation to | |
| | | | | participate | |
| | | | | actively in the | |
| | | | | learning | |
| | | | | experience. | |
| | | | | Other learners | |
| | | | | can see cause | |
| | | | | and effect from | |
| | | | | their | |
| | | | | participation, | |
| | | | | and become | |
| | | | | “referenceable” | |
| | | | | to other | |
| | | | | learners | |
| | | Do | To what | What is being | What is being |
| | | measurements | degree is the | measured has | measured has no |
| | | have value to | measurement | high value and | value to the |
| | | the learner | relevant to the | positive or | learner |
| | | | outcomes the | negative | |
| | | | learner values. | consequence | |
| | | | | to the learner. | |
| | | Economic value | What is the | Learning | Learning |
| | | of learning | economic | experience | experience |
| | | experience | value to the | provides | provides no |
| | | | learner from | access to | immediate or |
| | | | the learning | increased | future economic |
| | | | experience. | income levels, | value to the |
| | | | Does this | both current | learner |
| | | | provide access | and future, and | |
| | | | to incremental | is valued | |
| | | | levels of | financially by | |
| | | | income or | the | |
| | | | financial | organization | |
| | | | reward. | the learner | |
| | | | | belongs to. | |
| | Incentives | Incentives | To what | The learner is | There are no |
| | | driving | degree is the | provided with a | incentives |
| | | participation | learner | tangible | provided to the |
| | | | incented to | incentive to | learner, positive or |
| | | | participate in | participate, | negative. |
| | | | the learning | negative or | |
| | | | experience, in | positive, that is | |
| | | | either a | incremental to | |
| | | | negative or | the value of the | |
| | | | positive way. | learning | |
| | | | | outcome | |
| | | Incentives | To what | Incentives are | No incentives are |
| | | driving | degree do the | aligned with | in place |
| | | outcomes | incentives that | organizational | |
| | | | are in place | intent, and are | |
| | | | drive the | based on the | |
| | | | ultimate | measurable | |
| | | | outcomes that | outcomes that | |
| | | | the learning | are valued by | |
| | | | experience | the learner and | |
| | | | can provide. | the | |
| | | | | organization. | |
| | Time | Time to value | How long does | The value is | There time lapse |
| | | | it take for the | realized | from when the |
| | | | learner to | immediately | learning takes |
| | | | realize the | | place to when the |
| | | | value of the | | value is realized is |
| | | | personal | | protracted and |
| | | | investment | | subject to retention |
| | | | made in the | | erosion and |
| | | | learning | | obsolescence. |
| | | | experience. | | |
| | Performance | Impact on | To what | Job | There is no impact |
| | | ability to | degree does | performance is | on the learners |
| | | perform | the learning | highly | ability to perform |
| | | | experience | enhanced as a | on the job |
| | | | provide an | result of the | |
| | | | impact on the | time spent in | |
| | | | critical tasks | the learning | |
| | | | and | experience. | |
| | | | performance | | |
| | | | requirements | | |
| | | | of the learner | | |

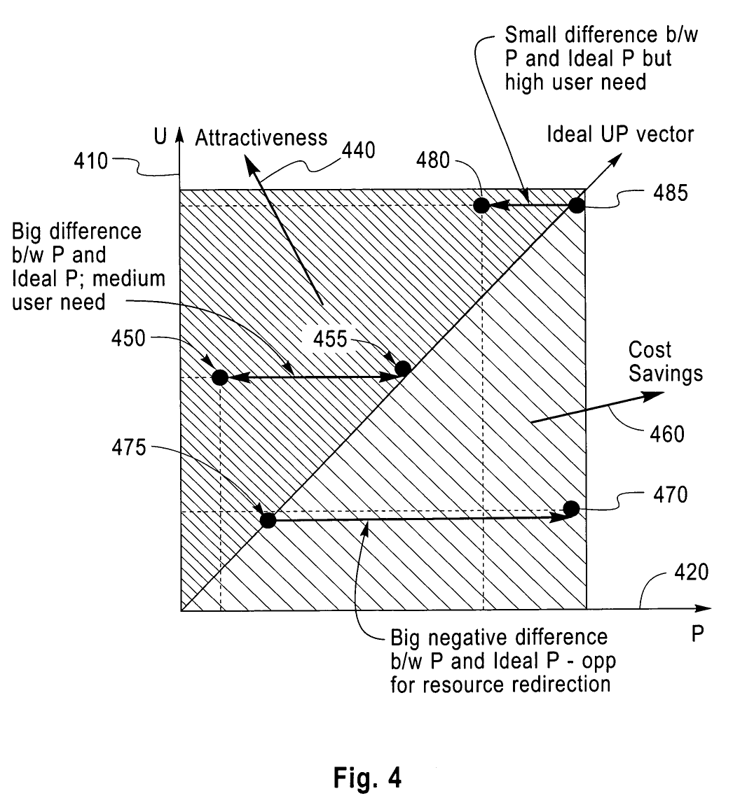

FIG. 4 is an illustration of an assessment and provisioning representation. The Y axis 410 represents the potential values for the assessment values (U). In one preferred embodiment, the values on the axis range from 1 to 10. The X axis 420 represents the potential values for the provisioning values (P). In one preferred embodiment, the values on the axis range from 1 to 10. Each variable is recorded as a point on the graph, determined by its U and P values. The “ideal UP vector” 430 represents the position of variables in the case when their U and P values are identical. This represents the most desirable condition, where each variable is satisfied by the learning program/service to the exact degree it is desired by the user. That is, 430 represents the best match between provisioning/investment and users' attractiveness to the learning. All the points above vector 430, in area 440, represent variables where the assessment value provided by the user is greater than the provisioning value provided by the learning program/service. Any variable in area 440 is a potential candidate for increasing its provisioning value in order to increase the attractiveness of the program/service to the user. For example, point 450 represents a variable with a big difference between the assessment value and the provisioning value. Point 480 represents a smaller difference between the two values. A way of visualizing the difference is to draw a horizontal line between a point in area 440, for example point 450, and a point on the vector 430 that has the same U value, its “ideal” counterpart, point 455. The distance between an actual variable (point 450) and its ideal counterpart (point 455) provides the difference measured by the system. The calculation is to subtract the P value of 450 from the “ideal” P value of 455. If the evaluation 230 uses absolute differences, the variable represented by 450 would represent a higher priority for being corrected than the variable represented by point 480 (because the distance between 480 and 485 is smaller than the distance between 450 and 455). But, as mentioned in the description of FIG. 2 above, if the difference is weighted by U, this priority may be reversed, as the U value of 480 is much higher than that of 450.

All the points below vector 430, in area 460, represent variables where the assessment value provided by the user is lower than the provisioning value provided by the learning program/service. Any variable in area 460 is a potential candidate for reducing its provisioning value in order to decrease the cost of the program/service without losing attractiveness to the user. For example, point 470 represents a variable with a big difference between the assessment value and the provisioning value. A way of measuring or visualizing the difference is to draw a horizontal line between a point in area 460, for example point 470, and a point on the vector 430 that has the same U value, 475. This difference is negative—subtracting the P value of 470 from the ideal P value of 475. Thus the sign (+/−) indicates if it's a gravitational difference or a cost saving difference.

Users 125, stakeholders 130, and consultants 190 can use the representation described in 400 in order to determine which variables could be adjusted.

FIG. 5 is a flow chart of an alternative process 500 performed by the present invention. The process refers to many of the same steps as in the process 200 of FIG. 2 and those steps will be numbered the same and have the same description as that of FIG. 2. However FIG. 5 describes the actions of the service provider 130 or learning consultant 190 in relation to the steps in 200. FIG. 5 describes the use of the steps in process 200 in providing services to one or more learning clients.

The consultant 190 will first determine variables or aspects of the program 501 that is being evaluated. This is done by associating 510 assessment values 210 with variables and associating 520 provisioning values 220 with variables. This associating will be done using techniques in the respective steps 210 and 220 above. However, the consultant 190 might use or add variables that the consultant 190 considers relevant. These relevant variables might come from the consultant's experience or from databases 170 that the consultant has developed in past engagements, e.g., historical data.

The consultant's motivation is to provide suggestions to the stake holder and/or user to improve the program/service. Typically this includes suggestions, designs, re-designs, and/or modifications to improve the program/service attractiveness to the user and/or to reduce the cost to the stake holder.

Therefore, the output 160 of the invention for the consultant 190 might have particular emphasis on how to improve the learning program/service. For example, the invention output 160 might be used as input to methods that increase attractiveness to the user 580 and/or decrease cost 590 to the stake holder (and/or user).

Another goal of the consultant 190 might be to improve the historical database 170 with the information developed under the study of the current learning program/service. For example, to build an improved database 170, data from the learning program/service under evaluation are collected and stored.

If the data collected for the current engagement match the format of the historical database 170, the data can be combined with the historical data in the database. If the data collected for the current engagement do not match the format of the historical database, possibly changes to the model relating data to the measures of attractiveness might be required.

Analysis of the weightings in the database 170 can provide useful insight to the consultant. For example, the weight determined from an historical database can provide baseline ranking and/or weights for program aspects, particularly for programs/services in similar domains or industries, e.g., corporate training. Relative values of weights might give an indication of “biggest gap”—which factor is the outcome most sensitive to. Importance to an industry, program type, or business goal of a particular program aspect might be related to the weighting across the data in the database 170.

In many situations, the consultant 190 uses the invention where the individual user 125 is given the freedom to choose whether or not to participate in the learning program/service. Therefore, the consultant needs to determine what causes the user 125 to choose the learning program/service, e.g., what is attractive to the user. Therefore, while the invention is primarily used to make learning programs more attractive to the user, the same invention 100 could be used to make any choice, e.g., a product purchase choice, more attractive to the user.

We claim:

1. A computer system for evaluating the attractiveness of a learning program for one or more end users, the system comprising:
one or more databases having one or more variables, each of the variables defining one or more aspects of the learning program;
an assessment value associated with each of the variables, the assessment value being a combination of two or more importance assessments given by one or more of the users for the respective aspect;
a provisioning value associated with each of the variables, the provisioning value being a combination of two or more availability assessments given by one or more stake holders for the respective aspect; and
an evaluation process that for one or more of the respective variables determines a measure of a difference between the assessment value and the respective provisioning value, the evaluation process further providing a report of the measure with the respective aspects.

2. A system, as in claim 1, further comprising an aggregation process that combines two or more of the measures to obtain a program measure, the program measure being an indication of an attractiveness of the learning program/service to the users.

3. A system, as in claim 1, further comprising a ranking process that ranks the aspects by the measure.

4. A system, as in claim 3, where the aspects having variables with high assessment values and low provisioning values are pre-selected and ranked.

5. A system, as in claim 1, where the measure is determined by a measuring process which, for each variable associated with an aspect, multiplies the respective assessment and provisioning values to obtain an aspect measure.

6. A system, as in claim 1, where the measure is determined by a measuring process which, for each variable associated with an aspect, computes a distance between the assessment value and the provisioning value for the respective aspect to obtain the measure.

7. A system, as in claim 1, where one or more of the measures are weighted by measure weights.

8. A system as in claim 1, where one or more of the assessment values are weighted by assessment weights.

9. A system, as in claim 7, where the measure weights are determined by one or more of the following: the assessment value, one or more historical aspect measures, one or more historical aspect measures in a history of a similar learning program/service, a predetermined value.

10. A system, as in claim 1, where the variables are categorized in one or more of the following factors: quality, value, and access.

11. A system, as in claim 1, where one or more of the variables are categorized in a quality factor and further categorized in one or more of the following components: production values, individualization, and end user support.

12. A system, as in claim 1, where one or more of the variables are categorized in a value factor and further categorized in one or more of the following components: measurement, incentive, time, and performance.

13. A system, as in claim 1, where one or more of the variables are categorized in an access factor and further categorized in one or more of the following components: technology, cost, awareness, time, mobility, and selection.

14. A system, as in claim 1, where the user includes one or more of the following: a soldier, an employee, a university student, a customer, an elementary school student, a high school student, a retired person, an e-learning student, a continuing education student, a web user, a special interest, and an ad hoc user.

15. A system, as in claim 1, where the stake holder includes one or more of the following: an learning provider, a publisher, an aggregator, a corporate officer, a government, a government agency, a university, an learning institution, a corporation, a community college, an online university, an online high-school, an online elementary school, a certification program and an industry association.

16. A service method for evaluating a learning service, the service method comprising the steps of:
determining one or more variables, each of the variables defining one or more aspects of the learning service;
associating one or more assessment values with each of the variables, the assessment value representing an importance assessment given by one or more of the users for the respective aspect;
associating one or more provisioning value with each of the variables, the provisioning value representing an availability assessment given by one or more stake holders for the respective aspect;
determining a measure difference between the assessment value and provisioning value for each of one or more of the aspects; and
aggregating two or more of the measures to obtain a program measure, the program measure being an indication of an attractiveness of the learning service to the users.

17. A service, as in claim 16, where assessment value is determined by any one or more of the following: a face-to-face interview, an interview form, an on-line form, a conference call, and a focus group.

18. A service, as in claim 16, where provisioning value is determined by any one or more of the following: a face-to-face interview, an interview form, an on-line form, a conference call, and a focus group.

19. A service, as in claim 16, further comprising providing an evaluation report that associates one or more measures with the respective aspects.

20. A service, as in claim 16 further comprising the step of providing an evaluation report that associates one or more measures with the respective aspects in a ranked order.

21. A service, as in claim 16, further comprising the step of modifying the learning service to decrease the measured difference for one or more of the aspects in order to increase the attractiveness of the learning service to the users.

22. A service, as in claim 21, where the modifying is performed when the assessment value is high and the provisioning value is low.

23. A service, as in claim 16, further comprising the step of modifying the learning service to reduce the cost of the learning service the stake holder.

24. A service, as in claim 23, where the modifying is performed when the assessment value is low and the provisioning value is high.

25. A service, as in claim 16, further comprising the step of modifying the learning service to reduce the cost of the learning service to the user.

26. A service, as in claim 16, further comprising the step of modifying the learning service to improve the attractiveness of the learning service to the user.

27. A service, as in claim 16, further comprising the step of storing the aspects and the respective measures in a database.

28. A method for evaluating a learning service, the service method comprising the steps of:
determining one or more variables, each of the variables defining one or more aspects of the learning service;
associating one or more assessment values with each of the variables, the assessment value representing an importance assessment given by one or more of the users for the respective aspect;
associating one or more provisioning value with each of the variables, the provisioning value representing an availability assessment given by one or more stake holders for the respective aspect;
determining a measure difference between the assessment value and provisioning value for each of one or more of the aspects; and
aggregating two or more of the measures to obtain a program measure, the program measure being an indication of an attractiveness of the learning service to the users.

29. A system for evaluating a learning program, the system comprising:
means for determining one or more variables, each of the variables defining one or more aspects of the learning program/service;
means for associating one or more assessment values with each of the variables, the assessment value representing an importance assessment given by one or more of the users for the respective aspect;
means for associating one or more provisioning value with each of the variables, the provisioning value representing an availability assessment given by one or more stake holders for the respective aspect;
means for determining a measure difference between the assessment value and provisioning value for each of one or more of the aspects; and
means for aggregating two or more of the measures to obtain a program measure, the program measure being an indication of an attractiveness of the learning program/service to the users.
